(19) United States
(12) Patent Application Publication
(10) Pub. No.: US 2012/0179694 A1
(43) Pub. Date: Jul. 12, 2012

(54) METHOD AND SYSTEM FOR ENHANCING A SEARCH REQUEST

(75) Inventors: Vincenzo Sciacca, Rome (IT); Massimo Villani, Rome (IT)

(73) Assignee: INTERNATIONAL BUSINESS MACHINES CORPORATION, Armonk, NY (US)

(21) Appl. No.: 13/391,684

(22) PCT Filed: Aug. 17, 2010
(86) PCT No.: PCT/EP2010/061922

§ 371 Date: Feb. 22, 2012

(30) Foreign Application Priority Data
Sep. 28, 2009 (EP) 09171454.3

(51) Int. Cl. G06F 17/30

(52) U.S. Cl. 707/748; 707/759; 707/E17.062

(57) ABSTRACT

The invention provides a method and system for transforming a search query before it is sent to a search engine. The search query, written in a language potentially not mastered correctly by its writer, can comprise typos corresponding to the alphabetic representation of a sound in the writer native language. The search query is first interpreted so as to identify a sequence of phonemes corresponding to its pronunciation by the writer in its native language. The sequence of phonemes is then analyzed so as to determine the corresponding words.

### FIELD OF THE INVENTION

The present invention relates to a method and system for enhancing a search request, and more particularly for modifying the search request before it is sent to the search engine so as to correct potential typos made by a user.

### BACKGROUND OF THE INVENTION

Search engines are optimized for research in resources in English, as the English language dominates world-wide interesting web resources while other languages are less present. Users generally have at least a basic knowledge of English, but often the exact spelling of a particular English word is not known precisely by non native English speakers. Thus typos can occur in search requests, especially when written by the non native users of the language in which the request is written.

Usually search engines provide corrections hints for mistyped words, based of the fact that usually those words have few records found and the correct one much more and the correct one is found applying some distance criteria based on character differences (in a sort of hamming distance).

A “sounds-like” approach in databases has been implemented in known systems; however it does not capture the language knowledge but only basic technical similarities according to character distance or crude approximation like “I” sounds like “J” etc. The “sounds-like” approach was introduced as a mean to compensate the pronunciation ambiguities inside a single language particularly for English and more specifically for Name/Surname disambiguation when identical pronounced names/surnames were corresponding to completely different orthographies in the data-base.

### SUMMARY OF THE INVENTION

According to a first aspect of the present invention, there is provided a method for modifying a first text phrase to be searched in a set of resources written in a first language, comprising the steps of:

receiving a first message indicating a second language corresponding to the pronunciation of said first text phrase;

instructing a first phonetizer to generate a first phonetic transcription of said first text phrase using a pronunciation rule of said second language, said first phonetic transcription being dependent of said first language;

identifying a second text phrase in said first language, whose phonetic transcription as generated by a second phonetizer working in said first language is close to said first phonetic transcription; and

sending said second text phrase so that its occurrence in the set of resources is searched in lieu of the occurrence of said first text phrase.

An advantage of this aspect is that a non native speaker of the first language can run a search using pronunciation rules of her own language.

In a first development of the first aspect, any of the first or second phonetic transcriptions is generated using static pronunciation rules, or statistic pronunciation rules, or a combination of both.

An advantage is that the transcriptions can be made more accurate, and take into account the specific pronunciation rules of a particular user.

In a second development of the first aspect, the step of identifying the second text phrase further comprises the steps of:

determining a first set of phonetics elements comprised in said first phonetic transcription;

for any phonetic element of said first set, determining a corresponding orthographic element according to a transcription rule associated with said first language; and

aggregating the orthographic elements so determined to form said second text phrase.

An advantage is that a standard phonetizer can be used to perform that function.

In a third development of the first aspect, the second phonetizer acts as an inverse phonetizer, for transforming a phrase in a phonetic form in a phrase in an orthographic form, according to a predefined set of transcription rules.

An advantage is that a feedback loop can be used to improve the accuracy of the transcription rules and the general performance of the method. A further advantage is that the user preferences can be easily taken into account to increase the relevance of the results.

A further advantage is that the inverse phonetizer can be dynamically trained or statically designed to model the rules for transforming the phonemes into the orthographic form.

In a fourth development of the first aspect, a first variant to said first phonetic transcription is generated by said first phonetizer, and wherein a second variant to said second text phrase is identified by said inverse phonetizer, said method comprising the further step of deciding which text phrase between said second text phrase and said second variant is the most likely according to a ranking function.

An advantage is that ambiguities can be detected and resolved taking into account statistical data and/or static preferences.

In a fifth development of the first aspect, the ranking function orders text phrase by their number of occurrences in historical data.

An advantage is that past disambiguation can be leveraged to improve the results of the method.

In a sixth development of the first aspect, the method comprises the prior step of reordering the words of the first text phrase according to their natural alphabetical order.

An advantage is that the performance of the identification of the second text phrase can be greatly improved by limiting the search space to the text phrases wherein the words are arranged in the same order.

According to a second aspect of the present invention, there is provided an apparatus comprising means adapted for carrying out each step of the method according to the first aspect of the invention.

An advantage is that this apparatus can be obtained very easily, thus making the method easy to execute.

According to a third aspect of the present invention, there is provided a computer program comprising instructions for carrying out the steps of the method according to a first aspect of the invention when said computer program is executed on a computer.

An advantage is that the invention can easily be reproduced and run on different computer systems.

According to a fourth aspect of the present invention, there is provided a computer readable medium having encoded thereon a computer program according to the third aspect of the invention.

An advantage is that this medium can be used to easily install the method on various apparatus.

Further advantages of the present invention will become clear to the skilled person upon examination of the drawings and detailed description. It is intended that any additional advantages be incorporated therein.

### BRIEF DESCRIPTION OF THE DRAWINGS

Embodiments of the present invention will now be described by way of example with reference to the accompanying drawings in which like references denote similar elements, and in which:

FIG. 1 shows a high level view of a system suitable for implementing the present invention.

FIG. 2 shows a high level process for modifying a text phrase for a search engine.

FIG. 3 shows a high level process for obtaining a text phrase in an orthographic form from a sequence of phonemes.

### DETAILED DESCRIPTION OF THE PREFERRED EMBODIMENT

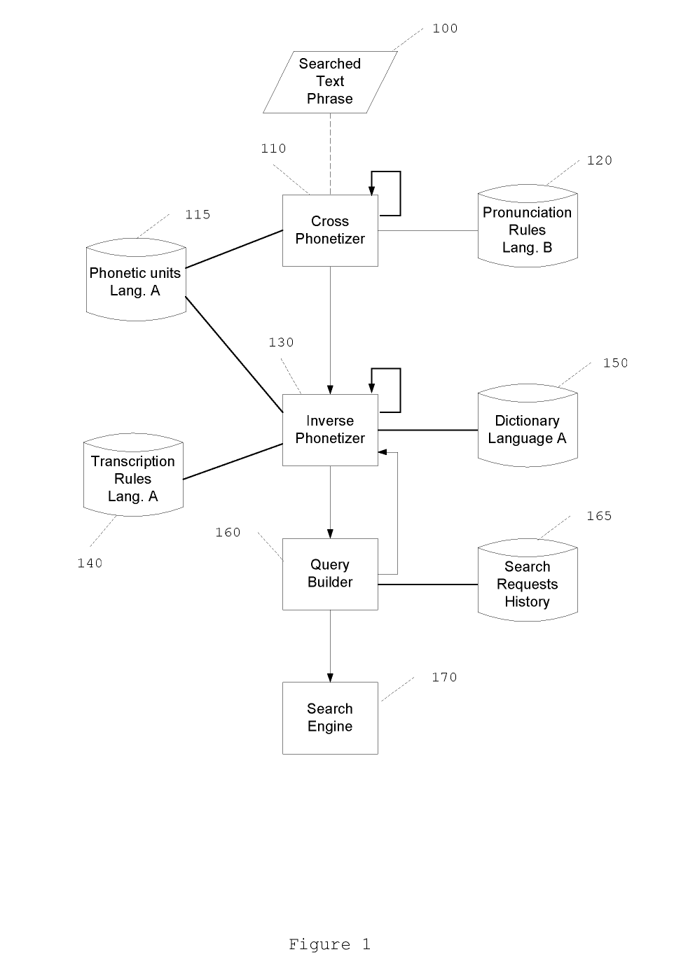

FIG. 1 shows a high level view of a system suitable for implementing the present invention, comprising:

a cross phonetizer (110) receiving a text phrase (100) to be searched as input, relying on a language A phonetic units database (115) and a language B pronunciation rules database (120);

an inverse phonetizer (130) relying on the language A phonetic units database (115), a language A transcription rules database (140) and a language A dictionary (150);

a query builder (160) relying on a history of search requests database (165); and

a search engine (170).

The text phrase (100) sent to the cross phonetizer (110) comprises words to be searched in a set of resources written in language A, for example English. However the user requesting the search to be performed is usually not a native speaker of language A. A common situation is that the user knows an approximate pronunciation of the words she wants to search, but she may not have a good enough command of language A for spelling the words correctly. In an implementation of the present invention, the user has the alternative of providing the text phrase (100) in an orthographic form corresponding to the pronunciation rules of language B, its native language (for instance Italian). Hence the user would be able to search for words in language A which sound like words spelled according to the pronunciation rules of language B. For example, a user, wanting to find the English word “thinking”, could request a search for words which sound like “tinchin” in an Italian orthographic representation. This step of representing a word in language A with the pronunciation rules of language B can be compared to transliteration. Transliteration is the process of representing a word with the corresponding characters of another alphabet. Transliteration is used to spell words usually written in a non-Latin alphabet, such as Arabic or Thai, with Latin letters. However, with transliteration, the pronunciation rules of a letter or word in language A remain those of language A. There is transliteration rule between two languages written with the same alphabet, such as Italian and English.

Receiving the text phrase (100) to be searched, the cross phonetizer (110) role is then to produce a phonetic transcription of this text phrase (100) in language A. This step is similar to what is done in the first phase of speech synthesis, wherein the conversion from the orthographic from, or grapheme, to a phonetic form relies on a lexicon for known tokens and grapheme to phoneme rules for unknown tokens. In an embodiment of the present invention, the pronunciation rules database (120) contains a mapping between an orthographic form of a token in language B and a phonetic representation of this token in language A. This mapping can be constructed using the text-to-speech techniques generally known for building the grapheme to phoneme rules in one particular language.

The phonetic units database (115) contain the set of phonetic characters which can be used to represent the text phrase (100) in a phonetic form. These phonetic characters can be specific to language A, or can alternatively be chosen among the International Phonetic Alphabet or the SAMPA, which is a computer readable phonetic alphabet. The cross phonetizer (110) is thus able to generate a phonetic representation in language A of the received text phrase (100). The performance of the cross phonetizer (110) can be improved using statistic training, such as decision trees or machine learning algorithm, language text archives of input-output couples, and dictionary lookup.

The inverse phonetizer (130) then produces an orthographic transcription in language A out of the phonetic transcription in language A produced by the cross phonetizer (110). This transcription is commonly performed by speech recognition systems, which identify the most likely word or sentence based on a sequence of detected phonemes. In a preferred embodiment, this identification is performed using static pronunciation rules applied to detected patterns in the phonemes received by the inverse phonetizer (130), or statistic pronunciation rules, relying on known algorithms such as the Viterbi search algorithm to identify the most likely word corresponding to the sequence of phonemes. The inverse phonetizer (130) relies on the transcription rules database (140) in language A comprising a mapping between phonemes and their alphabetic representation in language A, on the language A phonetic units database (115), which was already used by the cross phonetizer (110), and on language A dictionary (150) to identify the words which the user wants to search. The inverse phonetizer (130) performance can be improved by statistic training (decision trees, machine learning algorithm) on language text archives of input-output couples. The output of the inverse phonetizer (130) is then sent to the query builder (160) which will construct the search query intended by the user. In a preferred embodiment, the query builder (160) leverages a historical database of search requests (165) to identify the word or combination of words which were the most frequently requested. This result can be also sent to the inverse phonetizer (130) so that its performance is improved by relying on known learning techniques.

The search query is then sent to the search engine (170) so that resources matching the search query can be found.

The advantage of using this system is that is more practical for the user to approximately define how a word sounds and get corrected results. With users which are not skilled enough in language A, there is a high probability to mistype a word. These steps acts like a normalization of the search query.

Additionally this resolve a practical technical problem to lookup for huge amount of possible combination of possibilities if one wants to solve this problem according to a dictionary (hence by mean of a database lookup) approach: several joins of pronunciation variation-orthographic form tables are needed.

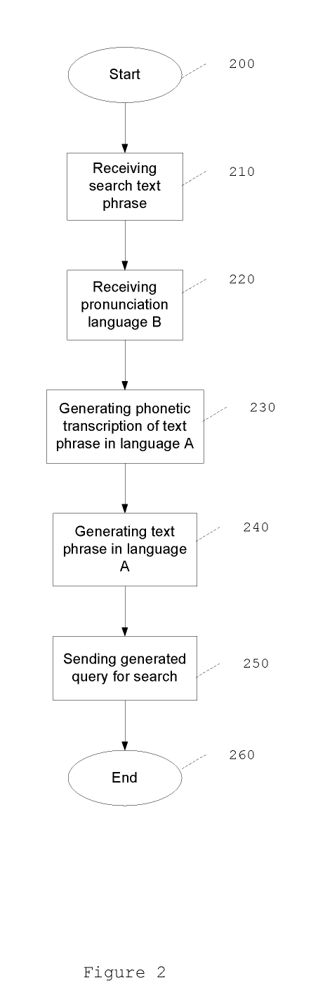

FIG. 2 shows a high level process for modifying a text phrase for a search engine, comprising the steps of:

starting the modification process (200);

receiving the search text phrase (210);

receiving an indication that the words in the search text phrase have been written according to the pronunciation rules of language B (220);

generating a phonetic transcription in language A of the search text phrase (230);

generating the search text phrase in language A (240);

sending the generated text phrase for search in a set of resources in language A (250); and

ending the modification process (260).

The received text phrase (210) is written in language A as the search will occur in a set of resources written in language A, however the user has written the words of the text phrase to be searched according to the pronunciation rules of language B with which she is more familiar. Thus the text phrase read according to the pronunciation rules of language B could be understood by a user understanding language A.

The following steps objective is to identify the words in language A which were meant by the user. To that end, the pronunciation rules of language B are received (220).

The phonetic transcription in language A of the text phrase (230) followed by the generation of the text phrase written with correct words of language A corresponds to a normalization of the received text phrase. These two steps mitigate common pronunciation errors of users native of language B, because the phonetizers take into account the pronunciation of a particular language.

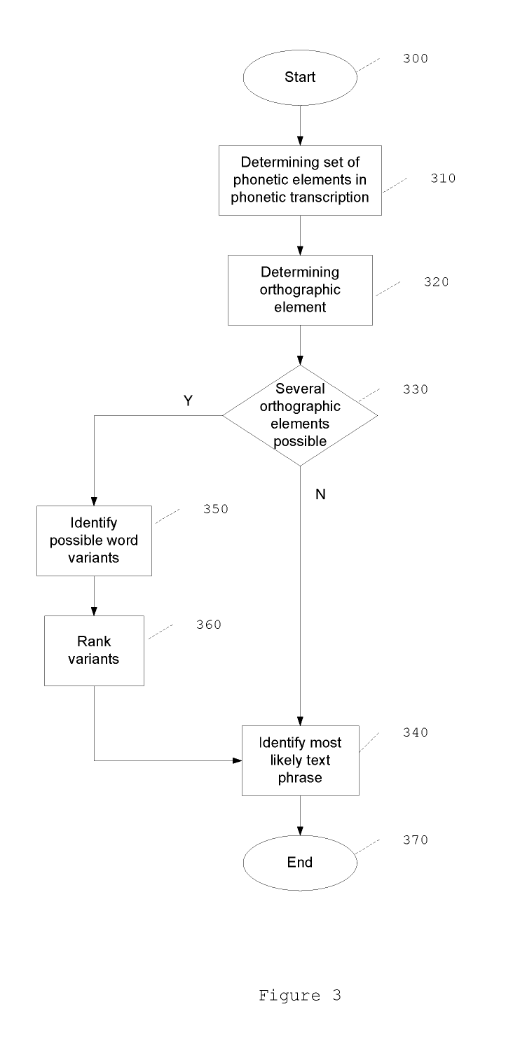

FIG. 3 shows a high level process for obtaining a text phrase in an orthographic form from a sequence of phonemes, comprising the steps of:

starting the process of identifying the text phrase meant by the user (300);

determining the set of phonetic elements in the phonetic transcription (310) of the words received by the cross phonetizer (110);

for each phonetic element, determining one or more corresponding orthographic elements;

if several orthographic elements are possible (330), identifying the possible word variants (350), and ranking these variants (360) to determine the most likely variant;

identifying the most likely text phrase (340); and

ending the text phrase identification process (370).

If, for a phonetic element, only one orthographic element is possible (330), then it may not be necessary to search for possible variants for a word and this step can be skipped to save computational time, and the step of identifying the most likely text phrase (340) can be executed directly.

The process of generating a phrase out of a sequence of phonemes is a problem commonly tackled by specific components in speech recognition systems, whose teachings can benefit implementations of the present invention. For instance speech recognition techniques use grammar to represent possible utterances made by the user. Grammars can be defined according to the Speech Recognition Grammar Specification developed by the W3C. In the particular case of the recognition of search text phrases, a particular grammar must be used as the text phrase is not constructed as a regular sentence, such as subject, a verb, etc. In a preferred embodiment of the present invention, the grammar used to identify the most likely text phrase (340) can describe the most frequent combination of words, as identified in a database containing historical information on run queries (165). As the words to be searched can validly be provided in any order by the user, a grammar suitable for the present invention must describe as equally acceptable a sequence of words in any order: A B C would be equivalent to B C A, etc. Experience shows that user generally correctly type the first letter, and that pronunciation differences between two languages lead to different spellings mostly in the middle or at the end of the word. To simplify the identification of the text phrase, prior to being sent to the cross phonetizer (110), the words can be reordered according to their natural alphabetical order, and the identification (340) for the most likely text phrase would be performed on combination of words ordered according to the same order. Using the same order for reordering the received text phrase and for identifying the most likely text phrase (340) can thus greatly reduce the search space and improve the performance of the process.

Another embodiment comprises a method and system for transforming a search query before it is sent to a search engine. The search query, written in a language potentially not mastered correctly by its writer, can comprise typos corresponding to the alphabetic representation of a sound in the writer native language. The search query is first interpreted so as to identify a sequence of phonemes corresponding to its pronunciation by the writer in its native language. The sequence of phonemes is then analyzed so as to determine the corresponding words.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1-10. (canceled)

11. A method for modifying a first text phrase to be searched in a set of resources written in a first language, comprising:
receiving a first message indicating a second language corresponding to a pronunciation of the first text phrase;
instructing a first phonetizer to generate a first phonetic transcription of the first text phrase using a pronunciation rule of the second language, the first phonetic transcription being dependent on the first language;
identifying a second text phrase in the first language;
instructing a second phonetizer working in the first language to generate a second phonetic transcription of the second text phrase, wherein the second phonetic transcription is similar to the first phonetic transcription; and
sending the second text phrase so that its occurrence in the set of resources is searched in lieu of the first text phrase.

12. The method of claim 11, wherein any of the first or second phonetic transcriptions is generated using static pronunciation rules, or statistic pronunciation rules, or a combination of static pronunciation rules and statistic pronunciation rules.

13. The method of claim 11, wherein the identifying the second text phrase further comprises:
determining a first set of phonetics elements comprised in the first phonetic transcription;
for any phonetic element of the first set, determining a corresponding orthographic element according to a transcription rule associated with the first language; and
aggregating the orthographic elements so determined to form the second text phrase.

14. The method of claim 11, wherein the second phonetizer acts as an inverse phonetizer, for transforming a phrase in a phonetic form into a phrase in an orthographic form, according to a predefined set of transcription rules.

15. The method of claim 14, wherein a first variant to the first phonetic transcription is generated by the first phonetizer, and wherein a second variant of the second text phrase is identified by the inverse phonetizer, the method further comprising:
selecting the second text phrase or the second variant of the second text phrase according to a ranking function.

16. The method of claim 15, wherein the ranking function orders text phrases based on a number of occurrences of the text phases in historical data.

17. The method of claim 11, further comprising reordering words of the first text phrase according to natural alphabetical order.

18. An apparatus for modifying a first text phrase to be searched in a set of resources written in a first language, comprising:
a system for receiving a first message indicating a second language corresponding to a pronunciation of the first text phrase;
a system for instructing a first phonetizer to generate a first phonetic transcription of the first text phrase using a pronunciation rule of the second language, the first phonetic transcription being dependent on the first language;
a system for identifying a second text phrase in the first language;
a system for instructing a second phonetizer working in the first language to generate a second phonetic transcription of the second text phrase, wherein the second phonetic transcription is similar to the first phonetic transcription; and
a system for sending the second text phrase so that its occurrence in the set of resources is searched in lieu of the first text phrase.

19. The apparatus of claim 18, wherein any of the first or second phonetic transcriptions is generated using static pronunciation rules, or statistic pronunciation rules, or a combination of static pronunciation rules and statistic pronunciation rules.

20. The apparatus of claim 18, wherein the system for identifying the second text phrase is further configured to:
determine a first set of phonetics elements comprised in the first phonetic transcription;
for any phonetic element of the first set, determine a corresponding orthographic element according to a transcription rule associated with the first language; and
aggregate the orthographic elements so determined to form the second text phrase.

21. The apparatus of claim 18, wherein the second phonetizer acts as an inverse phonetizer, for transforming a phrase in a phonetic form into a phrase in an orthographic form, according to a predefined set of transcription rules.

22. The apparatus of claim 21, wherein a first variant to the first phonetic transcription is generated by the first phonetizer, and wherein a second variant of the second text phrase is identified by the inverse phonetizer, the apparatus further comprising:
a system for selecting the second text phrase or the second variant of the second text phrase according to a ranking function.

23. The apparatus of claim 22, wherein the ranking function orders text phrases based on a number of occurrences of the text phases in historical data.

24. The apparatus of claim 18, further comprising:
a system for reordering words of the first text phrase according to natural alphabetical order.

25. A computer program, encoded on a computer readable medium, for performing a method for modifying a first text phrase to be searched in a set of resources written in a first language, when executed by a computer device, the method comprising:
receiving a first message indicating a second language corresponding to a pronunciation of the first text phrase;
instructing a first phonetizer to generate a first phonetic transcription of the first text phrase using a pronunciation rule of the second language, the first phonetic transcription being dependent on the first language;
identifying a second text phrase in the first language;
instructing a second phonetizer working in the first language to generate a second phonetic transcription of the second text phrase, wherein the second phonetic transcription is similar to the first phonetic transcription; and
sending the second text phrase so that its occurrence in the set of resources is searched in lieu of the first text phrase.

26. The computer program of claim 25, wherein any of the first or second phonetic transcriptions is generated using static pronunciation rules, or statistic pronunciation rules, or a combination of static pronunciation rules and statistic pronunciation rules.

27. The computer program of claim 25, wherein the identifying the second text phrase further comprises:
determining a first set of phonetics elements comprised in the first phonetic transcription;
for any phonetic element of the first set, determining a corresponding orthographic element according to a transcription rule associated with the first language; and
aggregating the orthographic elements so determined to form the second text phrase.

28. The computer program of claim 25, wherein the second phonetizer acts as an inverse phonetizer, for transforming a phrase in a phonetic form into a phrase in an orthographic form, according to a predefined set of transcription rules.

29. The computer program of claim 28, wherein a first variant to the first phonetic transcription is generated by the first phonetizer, and wherein a second variant of the second text phrase is identified by the inverse phonetizer, the method further comprising:
selecting the second text phrase or the second variant of the second text phrase according to a ranking function.

30. The computer program of claim 29, wherein the ranking function orders text phrases based on a number of occurrences of the text phases in historical data.

31. The computer program of claim 25, wherein the method further comprises reordering words of the first text phrase according to natural alphabetical order.
